(19) United States
(12) Patent Application Publication
(10) Pub. No.: US 2007/0086033 A1
(43) Pub. Date: Apr. 19, 2007

(54) Media distribution methods and systems with quality degradation

(75) Inventor: Edgar A. Tu, Castro Valley, CA (US)

Correspondence Address: CARR & FERRELL LLP, 2200 GENG ROAD, PALO ALTO, CA, 94303, US

(73) Assignee: Sony Computer Entertainment Inc.

(21) Appl. No.: 11/251,293

(22) Filed: Oct. 14, 2005

(51) Int. Cl. G06K 15/00

(52) U.S. Cl. 358/1.12

(57) ABSTRACT

Methods and apparatus are provided for copying digital content, such as videos and feature-length movies, that introduce a degree of degradation into each successive copy generation. The introduced degradation can take many different forms, from noise that emulates the noise introduced by analog copying, to reductions in the numbers of colors used. The methods and apparatus can also comprise transcoding the digital content.

### BACKGROUND OF THE INVENTION

1. Field of the Invention

The present invention relates generally to the entertainment industry and more particularly to systems and methods for encouraging sharing of digitized entertainment content.

2. Description of the Prior Art

Most forms of entertainment, such as music, movies, stage performances, and so forth, are amenable to being recorded for later playback. Analog recordings, such as on audio or video tape, tend to degrade with time. Moreover, further resolution is lost when analog copies are made of analog recordings. Until the rise of digital recording technologies, this loss of fidelity with successive generations tended to drive consumers of entertainment content to purchase legitimate copies of analog recordings from authorized sources in order to enjoy the highest fidelity.

However, digital recordings do not meaningfully degrade with time or with successive generations. Digital recordings can also be easily transmitted over networks and stored on a wide variety of media. The retention of fidelity, coupled with the general ease of transmission and storage, has lead to widespread illegal copying of all forms of digital content, and especially entertainment content such as music and movies. While the bandwidths of typical high-speed connections, such as DSL and cable modems, is insufficient to enable the rapid (i.e. on the order of minutes) transmission of feature-movies, length movies, it is expected that improvements in bandwidth will eventually make even movie sharing commonplace.

Since illegal copying deprives the creators and owners of the entertainment content of their profits, preventing such copying has become a major goal of the entertainment industry. Controlling the authorized distribution of digital content is sometimes referred to as Digital Rights Management (DRM). However, typical schemes for DRM are inconvenient for the end-user, and therefore unpopular.

### SUMMARY

An exemplary method for producing a degraded copy of digital content, according to one embodiment of the present invention, comprises receiving the digital content, degrading the digital content, and outputting the degraded digital content as the degraded copy. The method can further comprise determining whether the digital content has previously been degraded. Additionally, the method can further comprise transcoding the degraded digital content.

Degrading the digital content can include, for example, introducing noise to the digital content, and in some embodiments the introduced noise emulates the noise produced through analog copying. Degrading the digital content can also include replacing a percentage of pixels of a video recording with other values such as random values or a same value. Degrading the digital content can also include reducing a dynamic range of a sound recording, reducing the number of colors of a video recording, or reducing the luminosity of pixels of a video recording.

Degrading the digital content can include degrading every frame, or fewer than all of the frames, of a video recording. For example, every other frame or every third frame can be degraded. Frames can also be removed from a video recording of the digital content. Also, degrading the digital content can include reducing the image area of a video recording, overlaying a scroll bar over a video recording, or adding a fade effect. Degrading the digital content can also include using a compression codec that employs an insufficient number of bits in a compression algorithm than would otherwise be needed to faithfully represent the digital content.

An exemplary apparatus for degrading digital content, according to an embodiment of the present invention, comprises means for receiving digital content, means for degrading the digital content, and means for outputting the degraded digital content as the degraded copy. In some of these embodiments the means for degrading the digital content introduces noise to the digital content in a manner that emulates analog copying.

An exemplary multimedia home server, according to an embodiment of the present invention, comprises a digital content input for receiving digital content from a digital content source, electronics for degrading the digital content, and an output for providing the degraded digital content to a digital content player. In some embodiments the digital content input is configured to receive streaming media, and in some of these embodiments the electronics for degrading the digital content includes a dedicated processor. In further embodiments the dedicated processor is configured to transcode the degraded digital content.

### BRIEF DESCRIPTION OF DRAWINGS

FIG. 1 is a flowchart to illustrate an exemplary method for generating degraded copies of digital content, according to an embodiment of the present invention.

FIG. 2 is a schematic representation of an exemplary system for generating degraded copies of digital content, according to an embodiment of the present invention.

### DETAILED DESCRIPTION OF THE INVENTION

Methods for copying digital content, such as videos and feature-length movies, that introduce a degree of degradation into each successive copy generation. Apparatus for degrading digital content are also provided. The methods and apparatus of the present invention provide a number of benefits. One benefit is that consumers can rapidly create lower-quality copies of content for use in various media players. The lower-quality copies require less bandwidth to download to a media player and therefore can download much faster. Another advantage is that consumers can distribute lower-quality copies of content to others; the lower-quality copies serve as advertising. Thus, by allowing the free circulation of lower-quality copies of a feature-length movie, for example, other consumers that view the lower-quality copies may be inclined to purchase higher-quality copies of the movie.

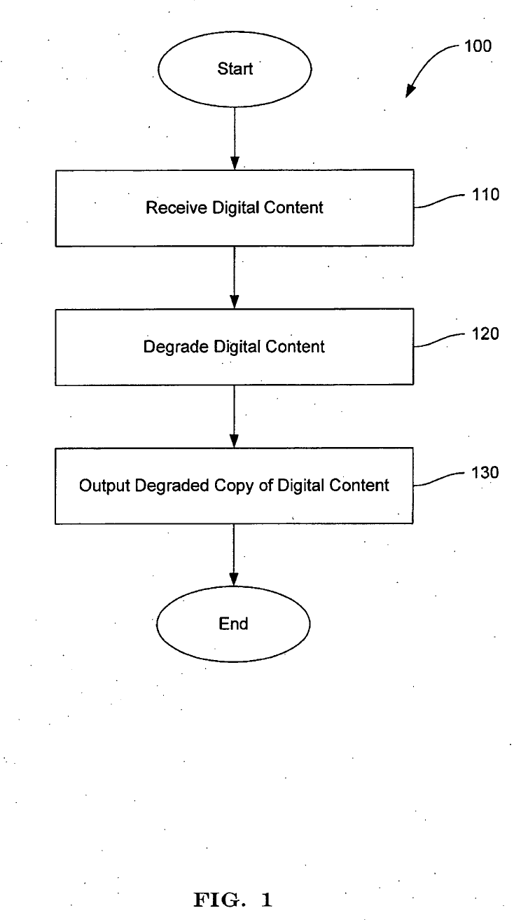

FIG. 1 illustrates an exemplary method 100 according to an embodiment of the invention. The method 100 comprises a step 110 of receiving digital content, a step 120 of degrading the digital content, and a step 130 of outputting a degraded copy of the digital content. It will be appreciated that although steps 110, 120, and 130 are shown in FIG. 1 as discreet steps that follow one after another, in many embodiments of the invention digital content is received, degraded, and output in real-time. Thus, in these embodiments all three steps are performed substantially contemporaneously.

In step 110 of FIG. 1 digital content is received. The digital content can be, for example, a music file, a video file, a movie file, or a video game, having a certain level of quality. For the purposes of this disclosure, commercial quality will denote a level of quality that is commercially available, for example, on a Digital Video Disc (DVD) or as a High-Definition Television (HDTV) broadcast signal. It will be appreciated that the digital content received in step 110 can have either commercial quality or less than commercial quality. For example, previously degraded digital content can be received in step 110.

Receiving digital content in step 110 can include receiving a storage medium containing the digital content, for example, by inserting a DVD into a DVD player or a flash memory device into a suitable reader. Receiving digital content can also include downloading a file or receiving streaming media over a broadband connection or through a broadcast. The received digital content can have a variety of formats. Examples include MPEG-3, MPEG-4, HDTV, standard TV, and Universal Media Disk (UMD).

In step 120 the digital content is degraded. Degrading the digital content comprises a reduction in the quality of the digital content, and can also comprise a change in the format thereof. A reduction in quality, as used herein, means a perceptible change in sound or image, or both, between the original digital content and the degraded copy made therefrom. When successive generations of copies are each degraded, the digital content will eventually be rendered unintelligible. In some embodiments, the quality of the digital content is degraded by about 10% each time it is degraded.

One form of degradation comprises the deliberate introduction of noise or alternative content to the digital content. For example, a certain percentage of bits or pixels can be replaced by random values, or the same value. Thus, for instance, the pixels of digital content comprising a video can be replaced with pixels of a certain color and brightness. With successive generations the frames of the video would be replaced by a uniform blue screen, for example. Alternately, a pattern or message can be made to appear over successive generations. In other embodiments, the effects of repeated analog copying can be emulated so that images become fuzzy or snowy and sound becomes increasingly staticy.

Another form of degradation can comprise reductions in dynamic range. Sound can be altered so that the frequency range is increasingly limited. This can be accomplished, for example, by clipping tones above and/or below certain thresholds. The thresholds can be brought closer together for successive generations so that eventually no sound remains. Alternately, the frequency range of the sound can be compressed in each generation so that any tone above a certain frequency is mapped to a somewhat lower frequency, while any tone below the certain frequency is mapped to a somewhat higher frequency. By either process, successive generations of sound would approach a monotone. A reduction in volume is another approach to dynamic range reduction. With successive generations the sound would become increasingly difficult to hear.

With respect to reducing the dynamic range of video, similar strategies can be employed. For example, the number of colors can be successively decreased from millions of colors to 256 k, to 128 k, and so on until all that remains is black and white. The luminosity of pixels can also be successively reduced. These techniques do not have to be applied to every frame of a video to be effective.

Other techniques for degrading video include removing frames or replacing frames. Still other techniques reduce the amount of the image that is displayed, for example, by overlaying a scroll bar across the bottom of the screen, or placing black side bars on either side of the screen, or placing the content in a frame. Similarly, content can be interrupted by advertising, messages, or blank screens, or pauses. As an example, a video can be degraded to include a 10 second pause every five minutes, or to periodically display a reminder message that the copy is degraded from the commercial quality. Fade effects, and the like can be applied to the edges of the display so that much of the center of the display retains commercial level quality, while the edges are made to be fuzzy or faded. Degradation can also be introduced through the use of a compression codec that employs an insufficient number of bits in the compression algorithm than would otherwise be needed to faithfully represent the original content. When uncompressed, the digital content will lack enough detail that it will be recognizable as degraded relative to the quality of the original digital content.

In a video game embodiment, degradation of a video game can include sound and video quality degradation as described above, and can also include content degradation, for example, reducing the number of levels of the video game that are available to play in a subsequent copy. For example, for an original video game of 15 game levels, a first generation copy would have only 14 levels, a second generation copy would have only 13 levels, and so on. In various embodiments, levels to be removed may be higher levels (reducing the overall level of complexity of the video game in subsequent copies), may remove lower levels (so that subsequent copies have only the harder levels), may remove intermediate levels (subsequent copies “jump” from easier levels to harder levels), combinations of these, or removal at random levels. Other content that can be removed with subsequent generations includes available characters, game control functions, event objects (e.g., bonus points, keys, etc.), and so forth.

It will be appreciated that in some embodiments degradation does not become worse with each successive generation. In these embodiments, the system performing the method of the invention is configured to determine how many generations of degradation the digital content has been subjected to, and, if a threshold number of generations has been met, to copy the digital content without further degradation. The threshold can be as little as one generation, in some embodiments. For example, where distributing lower-quality copies is desirable to advertise the content in order to entice more consumers to buy the commercial quality content, there is little value in requiring generations of digital content beyond the first or second generation be further degraded, as such poor copies would not help consumers appreciate the content enough to want to buy a higher quality version. In some instances, the generation of a copy can be inferred from the content itself by measuring a signal to noise ratio, for example. In other instances, a header at the beginning of the digital content includes a generation number.

As previously noted, degrading the digital content in step 120 can also comprise modifying the format of the digital content. Changing format is sometimes.referred to as transcoding. For example, the digital content can be transcoded from HDTV format to MPEG-4. It will be appreciated that transcoding algorithms are designed to preserve image quality through the conversion process. Thus, although some changes of format necessarily reduce resolution through a change in screen size, for example, this is not deemed to be degrading to the digital content. For the purposes of this disclosure, therefore, it will be understood that transcoding is not a form of degradation.

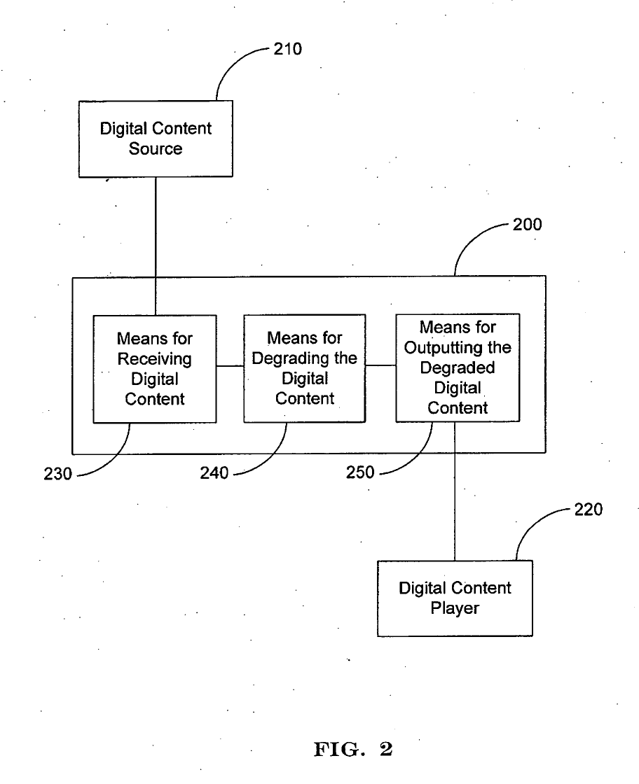

FIG. 2 illustrates an exemplary system 200 for producing a degraded copy of digital content, according to an embodiment of the present invention. The system 200 is configured to receive digital content from a digital content source 210 and to output the degraded copy to a digital content player 220. In some embodiments, the system 200 comprises a home server. A home server is a multimedia consumer electronics device for storing and managing different types of digital content such as photos, music, video, and so forth.

The digital content source 210 can comprise many different source types. For example, the digital content source 210 can comprise a radio frequency transmitter, a satellite transmitter, or a cable TV hub site for broadcasting a regular or HDTV signal. The digital content source 210 can also comprise a storage medium such as a DVD, hard drive, or flash memory device on which digital content can be stored. In some instances, the storage medium is a component of a consumer electronic device such as a DVD player or personal gaming device. Additionally, the digital content source 210 can comprise a network server for downloading digital content files or for streaming digital content.

The system 200 comprises means 230 for receiving digital content, means 240 for degrading the digital content, and means 250 for outputting the degraded digital content. The means 230 for receiving digital content is configured to receive digital content in one or more of the formats that can be provided by the digital content source 210. Accordingly, the means 230 for receiving digital content can comprise one or more of radio frequency (RF) tuner, a cable modem, a satellite receiver, a broadband modem, a DVD reader, a memory stick reader, and so forth. The means 230 also can comprise processors, buffers, storage devices, software, and firmware as necessary.

The means 240 for degrading the digital content receives the digital content from the means 230 for receiving the digital content. The means 240 for degrading the digital content comprises electronics configured to degrade the digital content as described above. In some embodiments, the means 240 is also configured to determine whether the digital content has been previously degraded and if so, to determine whether to further degrade the digital content. The means 240 can also comprise electronics configured to transcode the digital content either before or after degradation has been applied. Here, electronics can include processors, buffers, storage devices, software, and/or firmware, some or all of which may be shared with the means 230. In some embodiments, the means 240 includes a processor, such as a Cell chip, available from IBM Corp., that is dedicated to degrading and/or transcoding the digital content. Such a dedicated processor can allow real-time degradation and transcoding of streaming digital content.

The means 250 for outputting the degraded digital content provides the degraded digital content to the digital content player 220. The means 250 can include, for example, a wireless local area network (WLAN) access point or router, such as a WiFi router. Alternately, the means 250 can include a DVD burner, a Universal Media Disk (UMD) writer, a memory stick port, a broadband modem, and the like. The means 250 can also include more than one of the above to support different digital content data formats and different digital content players 220.

The digital content player 220 is configured to receive the degraded digital content for immediate or delayed playback. The digital content player 220 can comprise a television, digital video recorder (DVR), a portable DVD player, personal gaming device, personal computer, a PlayStation® portable (PSP™), or the like. A digital content player 220 that is not configured with a digital output is known as “closed-box” device. Digital content players 220 that do include a digital output can be used to freely distribute further copies of degraded digital content to other digital content players 220.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for producing a degraded copy of digital content, the method comprising:
receiving the digital content;
degrading the digital content; and
outputting the degraded digital content as the degraded copy.

2. The method of claim 1 wherein receiving the digital content includes receiving commercial quality digital content.

3. The method of claim 1 wherein receiving the digital content includes receiving a storage medium containing the digital content.

4. The method of claim 1 wherein receiving the digital content includes downloading a file containing the digital content.

5. The method of claim 1 wherein receiving the digital content includes receiving streaming media.

6. The method of claim 1 wherein degrading the digital content includes a reduction in quality of about 10%.

7. The method of claim 1 wherein degrading the digital content includes introducing noise to the digital content.

8. The method of claim 7 wherein introducing noise emulates analog copying.

9. The method of claim 1 wherein degrading the digital content includes replacing a percentage of pixels with other values.

10. The method of claim 9 wherein the other values are random values.

11. The method of claim 9 wherein the other values are the same value.

12. The method of claim 1 wherein degrading the digital content includes reducing a dynamic range of a sound recording.

13. The method of claim 1 wherein degrading the digital content includes reducing the number of colors of a video recording.

14. The method of claim 1 wherein degrading the digital content includes reducing the luminosity of pixels of a video recording.

15. The method of claim 1 wherein degrading the digital content includes degrading fewer than all of the frames of a video recording.

16. The method of claim 1 wherein degrading the digital content includes removing frames of a video recording.

17. The method of claim 1 wherein degrading the digital content includes reducing an image area of a video recording.

18. The method of claim 1 wherein degrading the digital content includes overlaying a scroll bar over a video recording.

19. The method of claim 1 wherein degrading the digital content includes adding a fade effect to a video recording.

20. The method of claim 1 wherein degrading the digital content includes using a compression codec that employs an insufficient number of bits in a compression algorithm than would otherwise be needed to faithfully represent the digital content.

21. The method of claim 1 further comprising determining whether the digital content has previously been degraded.

22. The method of claim 1 further comprising transcoding the degraded digital content.

23. An apparatus for degrading digital content comprising:
means for receiving digital content;
means for degrading the digital content; and
means for outputting the degraded digital content as the degraded copy.

24. The apparatus of claim 23 wherein the means for degrading the digital content introduces noise to the digital content in a manner that emulates analog copying.

25. A multimedia home server comprising:
a digital content input for receiving digital content from a digital content source;
electronics for degrading the digital content; and
an output for providing the degraded digital content to a digital content player.

26. The multimedia home server of claim 25 wherein the digital content input is configured to receive streaming media.

27. The multimedia home server of claim 25 wherein the electronics for degrading the digital content includes a dedicated processor.

28. The multimedia home server of claim 27 wherein the dedicated processor is configured to transcode the degraded digital content.
